(19) United States
(12) Patent Application Publication
(10) Pub. No.: US 2023/0036840 A1
(43) Pub. Date: Feb. 2, 2023

(54) METHOD AND SYSTEM FOR THE CONTROL OF A VEHICLE BY AN OPERATOR

(71) Applicant: Robert Bosch GmbH, Stuttgart (DE)

(72) Inventors: Alexander Geraldy, Hildesheim (DE); Holger Kiehne, Peine (DE); Jan Wolter, Hannover (DE); Jens Schwardmann, Hildesheim (DE); Peter Engel, Hessisch Oldendorf (DE)

(21) Appl. No.: 17/872,545

(22) Filed: Jul. 25, 2022

(30) Foreign Application Priority Data
Jul. 29, 2021 (DE) 10 2021 208 192.4

(51) Int. Cl. G05D 1/00

(52) U.S. Cl. CPC G05D 1/0022; B60W 60/001

(57) ABSTRACT

A method for the control of a vehicle by an operator. The method includes: using a predictive map to control the vehicle by: detecting a situation and/or location reference of the vehicle, transmitting data of a defined set of sensors, fusing and processing the data of the defined set of sensors; displaying the fused and processed data for the operator; creating/updating the predictive map by: recognizing a problematic situation and/or a problematic location by observation of the operator and/or marking by the operator, storing the problematic situation and/or the problematic location in a first database for storing problematic situations and locations, and training a model for selecting the defined set of sensors and fusing the data of the defined set of sensors by machine learning.

### CROSS REFERENCE

The present application claims the benefit under 35 U.S.C. § 119 of German Patent Application No. DE 10 2021 208 192.4 filed on Jul. 29, 2021, which is expressly incorporated herein by reference in its entirety.

### FIELD

The present invention relates to a method for the control of a vehicle by an operator. The present invention additionally relates to a corresponding system for the control of a vehicle by an operator, a corresponding computer program, and a corresponding memory medium.

### BACKGROUND INFORMATION

In teleoperated driving (ToD), a vehicle is remotely controlled from a distance using a wireless connection by an operator or an algorithm. Sensor data of the vehicle to be remote-controlled are sent to a remote control center and corresponding driving commands are sent back to the vehicle to be carried out. The use of teleoperated driving functions frequently takes place in conjunction with overcoming predicted or unpredicted situations or to overcome inadequacies in automated driving.

U.S. Patent Application Publication No. US 2019/0385460 A1 describes a method, using which teleoperated or automated vehicles are excluded from specific areas, localities, or routes, and a visualization of these areas in a map. German Patent Application No. DE 10 2016 001 264 A1 describes a similar system, which permits autonomous vehicles to drive exclusively in a limited region.

German Patent Application No. DE 10 2016 222 219 A1 describes a method, in which problem cases of autonomous vehicles, for example, (near) collisions or hazardous areas are sent together with the occurring geo-position to a cloud, in order to warn other drivers/vehicles of potential problems in this way.

U.S. Patent Application Publication No. US 2019/0271548 A1 describes the possibility of superimposing data from camera sensor and LIDAR sensor from a vehicle with object data from a map in order, among other things, to extend the vision, in that map data are displayed behind actual concealing objects. This technology not only takes place for static situations, but also during travel, in that a video is played back.

Methods for fusion of various sensors are described in the literature. U.S. Pat. No. 10,592,784 B1 describes, for example, a method for detection by fusion of multiple sensors; for example, the detection of a rumble strip by fusion of the data of the following three sensors: camera, microphone, and IMU (inertial measurement unit). Document DE 10 2018 008 442 A1 describes a method for weather and/or visual range recognition, which evaluates data of the LIDAR sensor with the aid of machine learning and fuses them with other types of surroundings detection sensors of the vehicle.

U.S. Patent Application No. US 2020/0160559 A1 describes a system and a method for carrying out a multitask and/or multisensor fusion for three-dimensional object recognition, for example, to promote the perception and control of autonomous vehicles.

China Patent Application No. CN 107976182 A describes a multisensor fusion mapping system, which includes a route planning module, a data detection module, a data fusion module, and a mapping module.

### SUMMARY

An object of the present invention described here is to enable operators optimized control of teleoperated vehicles in all regions and situations. It is central for this goal that an adequate representation of the vehicle surroundings, based on a variety of different sensors, is always available to the operator. A camera sensor is the standard sensor here. However, there is an array of situations in which the camera sensor does not supply an adequate surroundings model. For example, in bad weather or in darkness, the fusion of the camera image with the data from the radar or LIDAR sensor is capable of better displaying the vehicle surroundings to the operator. In addition, pieces of information from the infrastructure, for example, intersection sensors, or from other vehicles via V2X, may also be incorporated into the surroundings model.

In accordance with an example embodiment of the present invention, situations in which data of multiple sensors are to be fused with one another are defined not only by bad weather or temporal aspects, but are frequently also dependent on the local conditions. Therefore, a so-called predictive map is central for the present invention, which describes for all locations of the traveled route which sensors are to be fused with one another in which form and intensity. If an operator controls a teleoperated vehicle, with the aid of the predictive map, it is possible to predict and initiate data of which sensors are to be transmitted from the vehicle to a control center and how they are to be fused with one another.

A method for the control of a vehicle by an operator is described. The vehicle may be an automated or semiautomated vehicle which also permits teleoperation. The term “vehicle” is understood as mobile means of transportation which are used for the transport of people, goods, or tools. These include, for example, passenger vehicles, trucks, semitrailer trucks without cab, vehicles from the agricultural field such as robot mowers, general transportation robots, construction machines, drones, aircraft in which teleoperation is used as a backup, trains, delivery vehicles/robots, container transporters, tugboats, and cranes.

When carrying out the method described according to an example embodiment of the present invention, the predictive map is used to control the vehicle in order to carry out optimal fusing of sensor data, which supplies the best possible representation to the operator.

The predictive map may be viewed in the case of a local reference as a type of further layer of a roadmap or navigation map. For example, it is indicated at an intersection of two roads in the roadmap in the predictive map that, when an operator steers a vehicle in, for example, the northerly direction, a first sensor, a second sensor, and additionally an optional third sensor are to be used to display the surroundings for the operator. In the case of specific situations, such as bad weather, darkness, or dazzling due to the sun, the predictive map does not represent a “classic” static map layer, but rather a more dynamic layer which always engages when the particular dependent situation occurs. This may take place independently of the specific location. For example, it may be shown for the situation “dazzling by sun” in the predictive map that the camera sensor is additionally fused with the LIDAR sensor for object recognition in order to display the surroundings in the best possible manner to the operator.

If the predictive map is used, the possible combinations of various sensors, namely switching over and changing the weighting of the sensors, are read out as a function of a spatial position or situation. Initially a situation and/or location reference of the vehicle is detected. Subsequently, data of a defined set of sensors are transferred. The data of the defined set of sensors are then fused and processed. The fused and processed data are subsequently displayed to the operator.

The term “sensor” in the meaning of the present invention is understood to include devices and systems which enable a comprehensive surroundings model of the vehicle to be controlled for the operator. The sensors are primarily situated at the vehicle, but may also be situated elsewhere, for example, in the road infrastructure or in parking garages. These include, for example, camera, LIDAR, radar, and ultrasonic sensors, V2X, IMU, microphone or microphone array, thermometer, rain sensor, infrared camera, and all sensors of the surrounding traffic and all other sensors of the vehicle to be controlled.

A digital roadmap may also be used as a sensor within the scope of the present invention, in that, on the one hand, sensor data are fused with the roadmap (expanded map matching) and, on the other hand, the digital roadmap may be the trigger for a fusion adaptation. If, for example, curves, turnoffs, tunnels, or slope changes are recognizable in the digital roadmap, relevant sensors and their fusing may be adapted to the upcoming or present situation. The digital roadmap is advantageously provided in a backend of a system for the control of the vehicle by an operator and does not first have to be transmitted from the vehicle. The digital roadmap may be stored for this purpose in any part of the system, but it is sufficient if parts of the map are acquired from the backend, for example, as an electronic horizon.

Fusion or fusing of data is understood as a priority-based or weighted combination of data of different sources with the goal of bringing about a shared result. The result may be a numeric result, an interpretation, or a representation of data here.

In accordance with an example embodiment of the present invention, the fusion may take place at arbitrary points of the system for the control of the vehicle, for example, in the vehicle, in a backend between the vehicle to be controlled and the operator, or also on the computer of the operator. The fusion may also be allocated onto multiple partial fusions at different points of the system, for example, to preprocess and reduce data prior to the wireless transmission and to process and finally fuse data after the wireless transmission. A fusion also does not have to take place uniformly for all sensor data from the surroundings, but rather may be applied adapted to partial areas of the surroundings.

The predictive map may be created/updated while the operator controls the vehicle. For the present position or for the present situation, for example, fog, the matching fusion parameters for this purpose are progressively loaded from the predictive map and the data of the defined set of sensors are transmitted according to these parameters, subsequently fused, and finally displayed to the operator.

The creation/update of the predictive map takes place in that a problematic situation and/or a problematic location is recognized by observation of the operator and/or marking by the operator. The problematic situation and/or the problematic location are subsequently stored in a first database for storing problematic situations and locations.

In accordance with an example embodiment of the present invention, a model, for example, a neural network, is trained to select the defined set of sensors and fuse the data of the defined set of sensors, by whose use the predictive map may be automatically created or updated. Recorded situations, including all sensor data and features which are incorporated in the predictive map, are simulated to teach a trained operator and this operator selects the sensors and priorities in such a way that he/she achieves the best view. This process may also take place iteratively (jumping forward and back multiple times in the scenario, driving through multiple times, various (trainer) operators) to obtain an optimized result. The model thus trained selects the prioritization and selection of the sensors upon application.

In accordance with an example embodiment of the present invention, to select a weighting with respect to the sensors from the detected situations, the following strategies may be followed:
If the operator switches over, for example, to a LIDAR sensor, this may be noted and carried out proactively the next time or at least the recommendation or the proposition to switch over may be submitted to the operator.
In the event of, for example, fog warning and/or at night/in twilight, not only a camera sensor is used while driving, but further sensors are switched on to thus indicate detected objects as a bounding box. This assists the operator in the recognition of other road users and at the same time increases the level of safety, since possible objects are detected and marked even before they become visible in the camera image.

In accordance with an example embodiment of the present invention, the transmission of sensor data takes place through a wireless network, for example, a mobile network or a WLAN. The wireless network also permits teleoperation from a distance. The sensor data to be transmitted from the vehicle to the backend cannot exceed the available data rate. Priorities may be assigned to the data streams which are based on parameters such as driving speed, traffic density, or weather. The parameters for determining the priorities may be detected not only at the point in time of the occurrence, but may also be stored in the predictive map. A method which enables a prediction of connection quality or quality of service (QoS) may be used within the scope of the present invention to check whether the sensor data may be transmitted at all at a specific location at a specific time.

Under certain circumstances it is not possible or reasonable to transmit the data of all sensors to the backend at any time, for example, if the transmission channel does not permit this or excessively high costs result. The sensors may therefore be differentiated into required sensors, whose data are to be transmitted in any case to the backend and displayed to the operator, for example, the camera image, and optional sensors, whose data the operator may explicitly request, or which are also to be transmitted automatically in special driving situations, for example, a siren in the surroundings. Whether and how the fusion of the data already takes place in the vehicle, in the backend, or only in the control center is decided statically on the basis of requests by the operator and/or dynamically on the basis of the existing situation by the system, as described above. An adapted reduction of the amount of sensor data by compression or selection of relevant details is also possible, as long as the requests of the operator are fulfilled.

In accordance with an example embodiment of the present invention, the predictive map may include a matrix which indicates whether and how data of individual sensors are fused with one another. A priority and/or a weighting of individual sensors are calculated here. For example, for a specific location or a specific situation, the data of a first sensor are to be fused using a weighting of 0.6, a second sensor using a weighting of 0.25, and a third sensor using a weighting of 0.15. In the case that the third sensor is optional and is therefore not also to be transmitted in the case of a mobile communication connection which is not absolutely perfect, it could also be recorded in the matrix how the proportion of the optional sensor is distributed to the required sensors, for example, ⅔ to the first sensor and ⅓ to the second sensor, so that the following distribution results for this case: the first sensor using a weighting of 0.7 and the second sensor using a weighting of 0.3.

In the fusion of sensor data, the different positioning of the sensors in the vehicle is to be known in order to equalize them in the fusion. Thus, for example, a transformation of pieces of 3D LIDAR information to the coordinates of a camera image taking into consideration the various sensor positions is to take place.

The transmission of data of acoustic sensors such as microphones may be initiated directly by the vehicle in case of the occurrence, for example, siren or driving over rumble strips. In the simplest case, the fusion may mean that the noises are played to the operator via headphones. However, it is also possible to attempt to recognize the noises in the vehicle or downstream components of the system and then have them incorporated in the fusion with the other sensors. In addition, it is also possible to attempt to determine the direction of the noise, for example, via a microphone array or via V2X, for example, ETSI CPM or CAM messages. This direction could then also be shown to the operator in addition in the visual surroundings model and additionally be used to employ the required sensor data quality for the area in which the source of the noise is suspected.

The observation of the operator is preferably carried out by detecting the stress level of the operator. If, for example, a high stress level of the operator is often observed at a location, this location may be marked as a potentially hazardous location and other operators are warned of this. A second operator could also be switched in for monitoring in order to provide more safety to the actively driving operator.

Additionally or alternatively, the observation of the operator may be carried out by the detection of the viewing direction of the operator, for example, by eye or head tracking. For example, rapid eye movements or a frequent look next to the road indicate a potentially hazardous situation.

However, it is also possible that the observation of the operator is carried out by detecting the behavior of the operator. For example, locations at which strong braking frequently takes place are potentially hazardous.

Problematic locations and/or situations may also be recognized by marking of locations and/or situations by the operator as critical, for example, using an extra button. For example, the operator may also add labels after the end of the trip about what was problematic there, and may possibly make optimization suggestions, for how an operator may proceed in future at the location or how the sensor data fusion is to be adapted.

An individualization by the operator is also possible, so that he/she has the option of switching on optional sensors always or depending on a specific situation.

The location of the occurrence of the above-described situations is then stored together with a description of the situation in the first database for storing problematic situations and locations. The data recorded there are aggregated with one another at a later point in time, from which the predictive map is created or updated, which is represented by a second database for storing situation-related and/or location-related detection, fusion, and display parameters.

The method provided according to the present invention preferably furthermore includes the following steps:
retrieving parameters for the upcoming routes and/or areas from the second database for storing situation-related and/or location-related detection, fusion, and display parameters, which the predictive map displays;
adapting the defined set of sensors, whose data are transmitted;
adapting the fusion of the sensor data;
adapting the representation for the operator.

The fusion of the data of sensors is preferably allocated onto multiple partial fusions.

The method provided according to the present invention preferably furthermore includes the following steps:
searching for recognized situations and/or locations in the first database;
evaluating the recognized situations and/or locations;
generating situation-adapted and/or location-adapted detection, fusion, and display parameters;
storing the situation-adapted and/or location-adapted detection, fusion, and display parameters in the second database.

After the search, an evaluation of identical situations and/or locations may be compiled. It is then checked whether the recognized situation and/or the recognized location is permanently critical. If the recognized situation and/or the recognized location is permanently critical, it is furthermore checked whether parameters are already present. If the parameters are already present, they are retrieved from the second database and taken into consideration when evaluating the recognized situation and/or the recognized location.

A further aspect of the present invention is to provide a system for the control of a vehicle by an operator according to the method provided according to the present invention.

The method according to the present invention is preferably carried out using one of the systems described hereinafter. Features described within the context of one of the systems accordingly apply to the method and, vice versa, features described within the context of the method apply to the systems.

The system provided according to an example embodiment of the present invention includes the following:
a vehicle which permits teleoperation,
an operator who controls the vehicle without direct line of sight based on pieces of vehicle and surroundings information,
sensors which enable a comprehensive surroundings model of the vehicle for the operator,
a predictive map for selecting the defined set of sensors and fusing the data of the defined set of sensors, which is configured to indicate whether and how data of individual sensors are fused with one another,
a wireless network for transmitting data of the sensors,
a control center for controlling the vehicle, and
a training system, which is configured to train the predictive map to select the defined set of sensors and fuse the data of the defined set of sensors as a function of the location, situation, and/or preferences of the operator.

The system provided according to an example embodiment of the present invention preferably furthermore includes a backend, in which data of sensors between the wireless network and the control center are processed. The backend may be a data processing center. The backend above all fulfills the purpose here of carrying out computing-intensive fusions of data of different sources, for example, different vehicles or infrastructure units, for example, traffic signs or traffic signal systems, and then transferring the data preprocessed to the control center.

The backend may be a part of the control center or may be separate from the control center.

The fusion of the data of individual sensors preferably takes place at arbitrary points of the system provided according to the present invention. For example, the fusion may take place in the vehicle, in the backend between the vehicle to be controlled and the operator, or also on the computer of the operator.

Furthermore, a computer program, which is configured to carry out the method according to the present invention, and a machine-readable memory medium, on which the computer program according to the present invention is stored, are provided.

The present invention enables the safe teleoperated control of a vehicle by an operator, in that he/she is always supplied with a comprehensive surroundings model of the vehicle, made up of the adapted fusion of data of various sensors.

### BRIEF DESCRIPTION OF THE DRAWINGS

Specific embodiments of the present invention are explained in greater detail on the basis of the figures and the following description.

FIG. 1 shows a schematic representation of the system according to the present invention for the control of a vehicle by an operator.

FIG. 2 shows a sequence of a data fusion of different sensors.

FIG. 3 shows a first camera image, in which the objects detected from the data of a LIDAR sensor are shown as a bounding box.

FIG. 4 shows a second camera image, in which data of a LIDAR sensor are shown as a LIDAR point cloud.

FIG. 5.1 shows a third camera image.

FIG. 5.2 shows a fusion image, in which data of a LIDAR sensor are shown as LIDAR point cloud in the third camera image.

FIG. 6 shows a sequence of the method according to the present invention.

### DETAILED DESCRIPTION OF EXAMPLE EMBODIMENT

In the following description of the specific embodiments of the present invention, identical or similar elements are identified by identical reference numerals, a repeated description of these elements being omitted in individual cases. The figures only schematically represent the subject matter of the present invention.

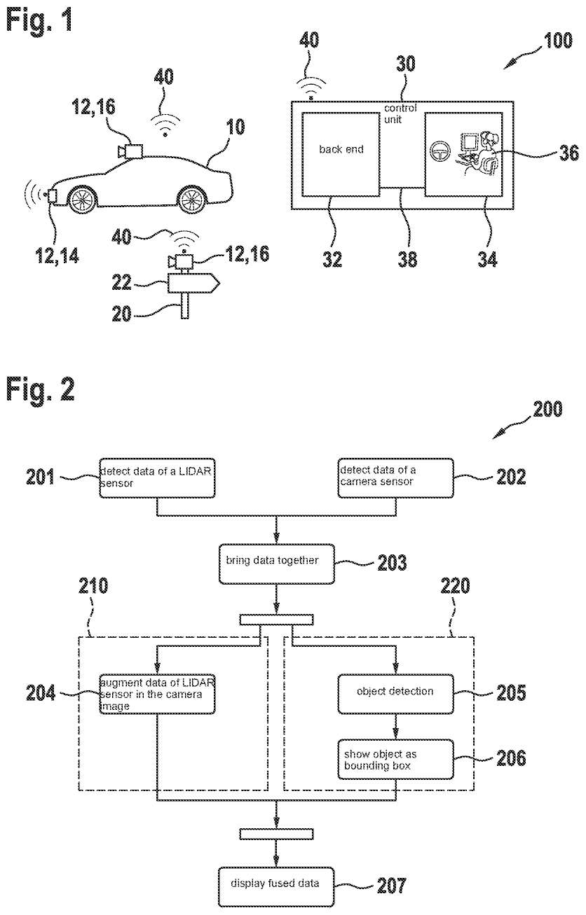

FIG. 1 schematically shows a system 100 according to the present invention for the control of a vehicle 10 by an operator 36. Vehicle 10 is an automated or semiautomated vehicle 10, which also permits teleoperation.

It may be seen from FIG. 1 that vehicle 10 to be controlled by operator 36 is equipped with two sensors 12, specifically a LIDAR sensor 14 and a camera sensor 16. Vehicle 10 may include further sensors 12, for example, radar sensor, ultrasonic sensor, and infrared camera. In the present case, camera sensor 16 is the standard sensor. However, there is an array of situations in which camera sensor 16 does not supply an adequate surroundings model. For example, in bad weather or in darkness, the fusion of the camera image with the data of LIDAR sensor 14 is capable of better displaying the vehicle surroundings to operator 36. In addition, pieces of information from infrastructure units 20 or from other vehicles 10 may also be incorporated into the surroundings model via V2X. In the present case in FIG. 1, infrastructure unit 20 shown is formed as a traffic sign 22, which is equipped with a sensor 12, namely a camera sensor 16.

Situations in which data of multiple sensors 12 have to be fused with one another are defined not only by bad weather or temporal aspects, but are often also dependent on the local conditions.

It is apparent from the representation according to FIG. 1 that system 100 according to the present invention, in addition to various sensors 12, furthermore includes a control unit 30, which includes a backend 32 and a control center 34, where operator 36 is located. System 100 furthermore includes a wireless network 40, which is designed, for example, as a mobile network or a WLAN and permits teleoperation of vehicle 10 from a distance. Operator 36 controls vehicle 10 from control center 34 without direct line of sight based on pieces of vehicle and surroundings information which are detected above all by sensors 12 of vehicle 10, and directly or indirectly controls the actuators of vehicle 10 via wireless network 40.

Backend 32 is designed here as a data processing center, in which the data of sensors 12 are processed between wireless network 40 and control center 34. In the present case in FIG. 1, backend 32 is separate from control center 34. Alternatively, backend 32 may also be part of control center 34. Backend 32 fulfills the purpose here above all of carrying out computing-intensive fusions of data of different sources, for example, different vehicles 10 or infrastructure units 20, and then transferring the data preprocessed via a data connection 38 to control center 34.

The fusion may take place at arbitrary points of system 100. The fusion may also be allocated onto multiple partial fusions at different points of system 100, for example, to preprocess and reduce data prior to the wireless transmission and to process and finally fuse data after the wireless transmission.

Thus, for example, an in-vehicle fusion of data of LIDAR sensor 14 and camera sensor 16 of vehicle 10 may be carried out. The fusion result is transmitted via wireless network 40 to backend 32.

Optionally, infrastructure unit 20, in the present case traffic sign 22, may be configured to fuse data of various sensors 12. The fused data are also transmitted to backend 32.

Backend 32 may be configured to receive the data sent from vehicle 10 and infrastructure unit 20, fuse them, and transmit the data fused there further to control center 34.

Control center 34 may also be configured to fuse the received data. The data thus fused are provided directly to operator 36, for example, via audiovisual or haptic devices.

FIG. 2 shows a sequence 200 of a data fusion of different sensors 12. The sequence of a fusion of data of a LIDAR sensor 14 and a camera sensor 16 is shown by way of example in FIG. 2.

Initially, data of a LIDAR sensor 14 are detected in a first step 201 and data of a camera sensor 16 are detected in a second step 202. Subsequently, the data of LIDAR sensor 14 and camera sensor 16 are brought together in a third step 203.

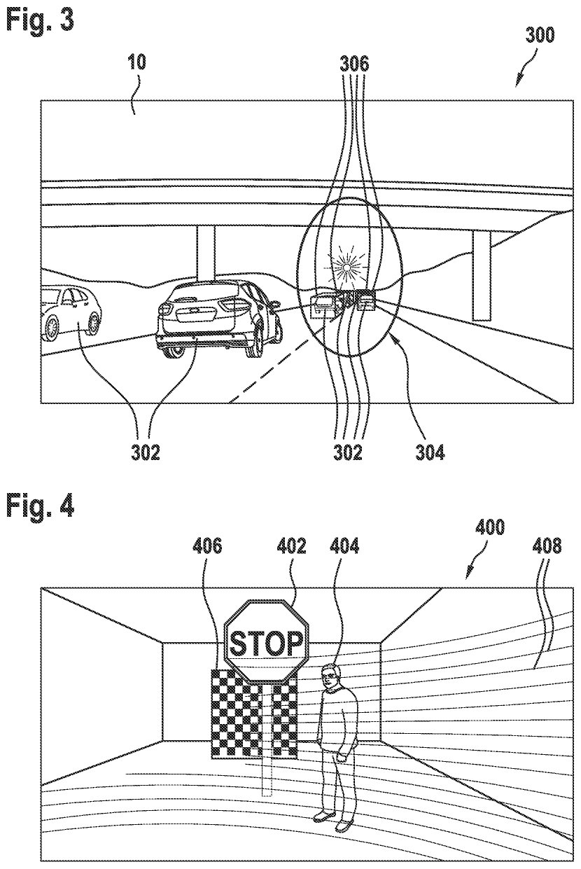

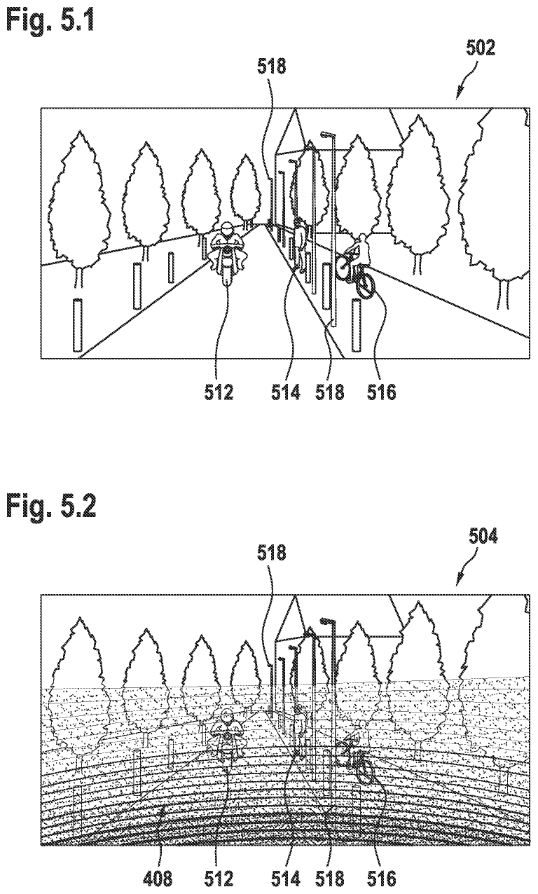

The data of LIDAR sensor 14 and camera sensor 16 are then fused with one another. There is not only one fusion possibility for a combination of two sensors 12. Two possibilities 210, 220 for fusing data of LIDAR sensor 14 and camera sensor 16 are shown in FIG. 2. In a first possibility 210, in a fourth step 204, the data of LIDAR sensor 14 are augmented as a LIDAR point cloud 408 (see FIGS. 4 and 5.2) in the camera image, while in a second possibility 220, initially, in a fifth step 205, an object detection is carried out from the data of LIDAR sensor 14, which is subsequently shown in a sixth step 206 as a bounding box 306 (see FIG. 3) in the camera image.

Finally, in a seventh step 207, the fused data of LIDAR sensor 14 and camera sensor 16 are displayed to operator 36.

FIG. 3 shows a first camera image 300, in which the surroundings of vehicle 10 are shown. Road users 302 are shown by a camera sensor 16. However, camera sensor 16 is disturbed by the sunshine in an area 304, so that road users 302 are not clearly recognizable in area 304.

In this situation, the data of camera sensor 16 are fused with the data of a LIDAR sensor 14 of vehicle 10. The fusion is carried out on the basis of a weighting of particular sensors 12. In the present case, a weighting of camera sensor 16 of 0.5 and a weighting of LIDAR sensor 14 of 0.5 are selected for an area 304 problematic for camera sensor 16. A weighting of camera sensor 16 of 1 [sic] is selected outside area 304.

Initially an object detection is carried out from the LIDAR data. The detected objects are subsequently shown to operator 36 as a bounding box 306 in first camera image 300.

FIG. 4 shows a second camera image 400, in which a stop sign 402, a person 404, and an obstacle 406 are shown. The data of a LIDAR sensor 14 are shown as LIDAR point cloud 408 in second camera image 400. Only the closest LIDAR points are visualized.

FIG. 5.1 shows a third camera image 502, in which a motorcycle rider 512, a pedestrian 514, a bicycle rider 516, and multiple streetlights 518 are recognized, while FIG. 5.2 shows a fusion image 504 in which the data of a LIDAR sensor 14 are shown as LIDAR point cloud 408 in third camera image 502. The distance is represented in the present case by different densities of points and thus different gray levels. The distance may also be represented by different color tones.

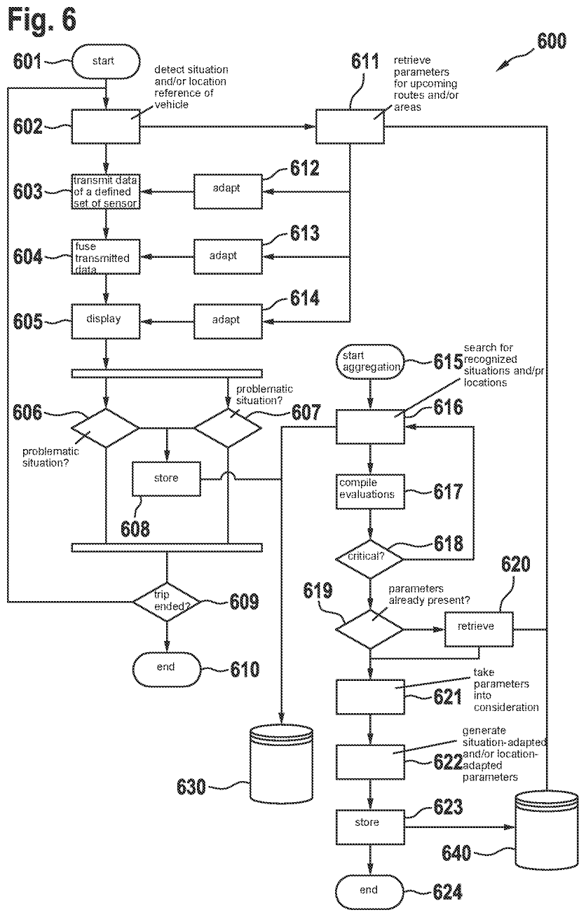

FIG. 6 shows an exemplary method sequence 600 for the control of a vehicle 10 by an operator 36.

In a first method step 601, the method according to the present invention is started. Vehicle 10 is controlled by operator 36. In a second method step 602, a situation and/or location reference of vehicle 10 is detected. Subsequently, data of a defined set of sensors 12 are transmitted in a third method step 603. The transmitted data are then fused in a fourth method step 604. The fused and processed data are then displayed to operator 36 in a fifth method step 605.

With the aid of method steps 602 through 605, a predictive map is used which may be updated during the control by operator 36. It is checked whether a problematic situation and/or a problematic location was recognized. A problematic situation and/or a problematic location may be recognized in a sixth method step 606 by observation of operator 36. A problematic situation and/or a problematic location may also, however, be recognized by marking by operator 36 in a seventh method step 607.

If a problematic situation and/or a problematic location are recognized, it and/or these are stored in an eighth method step 608 in a first database 630 for storing problematic situations and locations.

In a ninth method step 609, it is checked whether the trip is ended. If the trip is ended, the method is ended in a tenth method step 610. If vehicle 10 drives further, method steps 602 through 609 repeat.

In the creation of the predictive map, the detection, fusion, and display parameters are adapted if parameters are already present for the situation and/or location reference detected in second method step 602.

In an eleventh method step 611, the parameters for upcoming routes and/or areas are retrieved from a second database 640 for storing situation-related and/or location-related detection, fusion, and display parameters, which the predictive map displays. Subsequently, the defined set of sensors 12, whose data are transmitted, is adapted in a twelfth method step 612. The fusing of the data of sensors 12 is adapted in a thirteenth method step 613 and the display for operator 36 is adapted in a fourteenth method step 614.

If a problematic situation and/or a problematic location are recognized, an aggregation of data is carried out in parallel. The aggregation is started in a fifteenth method step 615 if a problematic situation and/or a problematic location are recognized.

A search is made for the recognized situations and/or locations in a sixteenth method step 616. Subsequently, in a seventeenth method step 617, an evaluation of identical situations and/or locations is compiled. In an eighteenth method step 618, it is then checked whether the recognized situation and/or the recognized location are permanently critical. Method steps 616 through 618 are repeated. If the recognized situation and/or the recognized location are permanently critical, it is furthermore checked in a nineteenth method step 619 whether parameters are already present. If the parameters are already present, they are retrieved in a twentieth method step 620 from second database 640 and taken into consideration when evaluating the recognized situation and/or the recognized location in a twenty-first method step 621. Subsequently, situation-adapted and/or location-adapted detection, fusion, and display parameters are generated in a twenty-second step 622, which are stored in a twenty-third method step 623 in second database 640. After the storage of the adapted parameters, the aggregation of data is ended in a twenty-fourth method step 624.

However, as already stated above in general, this selected sequence for carrying out the method according to the present invention in FIG. 6 is not the only one possible, since the fusion may also take place at any other position of system 100.

The present invention is not restricted to the exemplary embodiments described here and the aspects highlighted therein. Rather, a variety of modifications are possible within the scope of the present invention, which are within the expertise of those skilled in the art.

What is claimed is:

1. A method for control of a vehicle by an operator, comprising the following steps:
using a predictive map to control the vehicle by:
detecting a situation and/or location reference of the vehicle,
transmitting data of a defined set of sensors,
fusing and processing the data of the defined set of sensors,
displaying the fused and processed data for the operator; and
creating/updating the predictive map by:
recognizing a problematic situation and/or a problematic location by: observation of the operator and/or marking by the operator,
storing the problematic situation and/or the problematic location in a first database for storing problematic situations and locations, and
training a model for selecting the defined set of sensors and fusing the data of the defined set of sensors by machine learning.

2. The method as recited in claim 1, wherein the observation of the operator is carried out by detecting:
stress level of the operator, and/or
viewing direction of the operator, and/or
behavior of the operator.

3. The method as recited in claim 1, further comprising the following steps:
retrieving parameters for upcoming routes and/or areas from a second database for storing situation-related and/or location-related detection, fusion, and display parameters;
adapting the defined set of sensors, whose data are transmitted;
adapting the fusion of the data of the defined set of sensors;
adapting the display for the operator.

4. The method as recited in claim 1, wherein the fusion of the data of defined set of sensors is allocated onto multiple partial fusions.

5. The method as recited in claim 1, further comprising:
searching for recognized situations and/or locations in the first database;
evaluating the recognized situations and/or locations;
generating situation-adapted and/or location-adapted detection, fusion, and display parameters;
storing the situation-adapted and/or location-adapted detection, fusion, and display parameters in the second database.

6. A system for control of a vehicle by an operator, comprising:
a vehicle which permits teleoperation;
an operator who controls the vehicle without direct line of sight based on pieces of vehicle and surroundings information;
sensors, which enable a comprehensive surroundings model of the vehicle for the operator;
a predictive map to select the defined set of sensors and fuse the data of the defined set of sensors, which is configured to indicate whether and how data of individual sensors of the defined set of sensors are fused with one another;
a wireless network configured to transmit data of the sensors;
a control center configured to for control the vehicle; and
a training system configured to train the predictive map to select the defined set of sensors and use the defined set of sensors as a function of location, and/or situation, and/or preferences of the operator.

7. The system as recited in claim 6, further comprising:
a backend, in which the data of the defined set of sensors are processed between the wireless network and the control center.

8. The system as recited in claim 7, wherein the backend is a part of the control center or is separate from the control center.

9. The system as recited in claim 6, wherein the fusion of the data of the individual sensors takes place at arbitrary points of the system.

10. A non-transitory machine-readable memory medium on which is stored a computer program for control of a vehicle by an operator, the computer program, when executed by a computer, causing the computer to perform the following steps:
using a predictive map to control the vehicle by:
detecting a situation and/or location reference of the vehicle,
transmitting data of a defined set of sensors,
fusing and processing the data of the defined set of sensors,
displaying the fused and processed data for the operator; and
creating/updating the predictive map by:
recognizing a problematic situation and/or a problematic location by: observation of the operator and/or marking by the operator,
storing the problematic situation and/or the problematic location in a first database for storing problematic situations and locations,
training a model for selecting the defined set of sensors and fusing the data of the defined set of sensors by machine learning.
